(19) United States
(12) Patent Application Publication
(10) Pub. No.: US 2013/0090922 A1
(43) Pub. Date: Apr. 11, 2013

(54) VOICE QUALITY OPTIMIZATION SYSTEM AND METHOD

(71) Applicants: Hyeng Keun LIM, Seoul (KR); Won Seok PARK, Seoul (KR); Sang Woo SHIN, Seoul (KR)

(72) Inventors: Hyeng Keun LIM, Seoul (KR); Won Seok PARK, Seoul (KR); Sang Woo SHIN, Seoul (KR)

(73) Assignee: PANTECH CO., LTD., Seoul (KR)

(21) Appl. No.: 13/313,753

(22) Filed: Dec. 7, 2011

(30) Foreign Application Priority Data
Oct. 7, 2011 (KR) 10-2011-0102452

(51) Int. Cl. G10L 19/14

(52) U.S. Cl. 704/225; 704/E19.039

(57) ABSTRACT

The voice quality optimization system includes a controller that controls voice quality by adjusting parameters that control voice quality characteristics of the communication device; and a measuring unit that measures voice quality of the communication device and transmits the measured voice quality as a feedback to the controller. The controller controls voice quality by calibrating the parameters of the communication device, including a receiving sensitivity/frequency response characteristic curve, receiving loudness rating and idle channel noise-receiving. A method for setting voice optimization in a communication device includes measuring parameters of the communication device, determining whether the parameters of the communication device are within a target range, and calibrating a first parameter to be within the target range if the first parameter is outside the target range.

### CROSS-REFERENCE TO APPLICATION

This application claims priority from and the benefit under 35 U.S.C. §119(a) of a Korean Patent Application No. 10-2011-0102452, filed on Oct. 7, 2011, the entire disclosure of which are incorporated herein by reference for all purposes. Applicants also incorporate by reference the disclosures of “Developing The Automatic Voice Quality Optimization System for Mobile Communication Devices,” and “Analyzing Characteristics of Auto Gain Control for the Optimized Call Quality of Communication Device” in their entireties as if fully set forth herein.

### BACKGROUND

1. Field

The following description relates to a system and a method for automatically tuning voice quality optimization of a communication device.

2. Discussion of the Background

With the recent advent of a variety of communication devices, an increasing number of users are using the communication devices, which may provide a voice communication operation. Conventionally, manufacturers perform tuning of the communication devices by using specialized engineers in order to improve voice quality of these devices. However, since the voice quality may be determined by different individual engineers, there may be some deviation in voice quality among the communication devices. In addition, since time used to tune voice quality may be based on the individual engineer's skill, it may be difficult to uniformly maintain tuning time and voice quality.

### SUMMARY

Exemplary embodiments of the present invention provide a voice quality optimization system and a method for setting voice optimization in a communication device.

Additional features of the invention will be set forth in the description which follows, and in part will be apparent from the description, or may be learned by practice of the invention.

Exemplary embodiments of the present invention provide a voice quality optimization system including a measuring unit to obtain parameters of a communication device, in which the parameters comprise a receiving sensitivity/frequency response (RFR), receiving loudness rating (RLR), and idle channel noise-receiving (ICN-R); and a controller to determine whether the parameters of the communication device are within a target range, and to calibrate a first parameter to be within the target range if the first parameter is outside the target range.

Exemplary embodiments of the present invention provide a method for setting voice optimization in a communication device including measuring parameters of the communication device with a measuring unit, in which the parameter comprises at least one of a receiving sensitivity/frequency response (RFR), receiving loudness rating (RLR), and idle channel noise-receiving (ICN-R); determining with a controller whether the parameters of the communication device are within a target range; and calibrating a first parameter to be within the target range with the controller if the first parameter is outside the target range.

Exemplary embodiments of the present invention provide a method for setting voice optimization in a communication device including measuring parameters of the communication device, in which the parameters comprise a receiving sensitivity/frequency response (RFR), receiving loudness rating (RLR), and idle channel noise-receiving (ICN-R); determining whether RFR is within a target RFR range, and calibrating filter coefficient if RFR is determined not to be within the target RFR range; determining whether RLR is within a RLR range, and calibrating RLR parameter if RLR is determined not to be within the target RLR range; and determining whether ICN-R is within a ICN-R range, and calibrating ICN-R parameter if ICN-R is determined not to be within the target ICN-R range, in which RFR is rechecked to determine whether RFR remains within the target RFR range after RLR or ICN-R is calibrated, and RFR and RLR are rechecked to determine whether the RFR and the RLR remain within their respective target ranges after ICN-R is calibrated.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a voice quality optimization system according to an exemplary embodiment of the invention.

FIG. 2 is a flowchart illustrating a method for driving a voice quality optimization system according to an exemplary embodiment of the invention.

FIG. 3A illustrates a target receiving sensitivity/frequency response characteristic curve set in a voice quality optimization system according to an exemplary embodiment of the invention.

FIG. 3B illustrates a measured receiving sensitivity/frequency response characteristic curve in a voice quality optimization system according to an exemplary embodiment of the invention.

FIG. 4 is a graph illustrating idle channel noise-receiving parameters in a voice quality optimization system according to an exemplary embodiment of the invention.

FIG. 5 is a schematic diagram illustrating a voice quality optimization system according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present.

Hereinafter, a voice quality optimization system according to an exemplary embodiment of the present invention will be described.

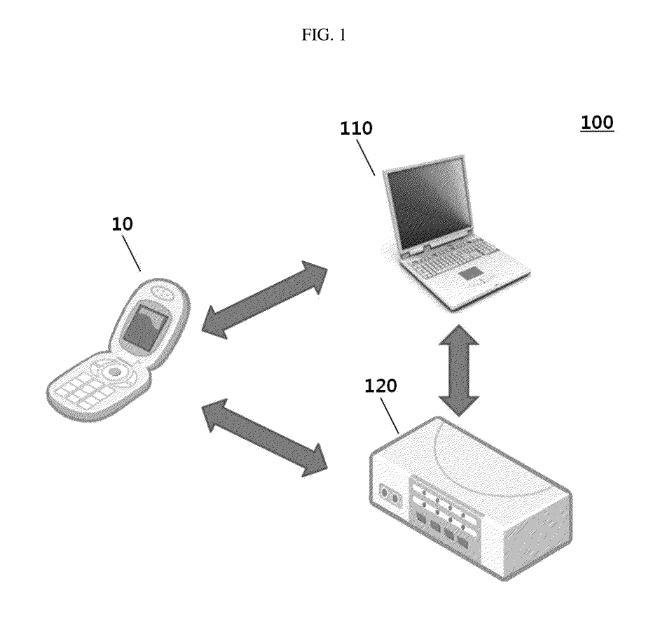

FIG. 1 is a schematic diagram illustrating a voice quality optimization system according to an exemplary embodiment of the invention.

As shown in FIG. 1, a voice quality optimization system 100 includes a controller 110 and a measuring unit 120. In the illustrated embodiment, the controller 110 and the measuring unit 120 are provided in separate devices, however, they may be provided in a single device.

The controller 110 may be electrically connected to a communication device 10. The connection may be made in a wired or wireless manner. The controller 110 may control one or more parameters of the communication device 10.

The controller 110 may perform parameter optimization in an order of voice quality characteristics to be measured. In an example, the voice quality characteristics to be measured may be arranged in the order of a receiving sensitivity/frequency response (RFR), a receiving loudness rating (RLR), and an idle channel noise-receiving (ICN-R) (collectively referred to as “measuring items”).

The RFR may refer to a receiving sensitivity/frequency response characteristic, the RLR may refer to a loss of a reception signal relative to a transmission signal, and the ICN-R may refer to a level of noise in a state in which mutual communication parties stay silent without talking. However, terms used to describe the measuring items and detailed measuring methods thereof may vary according to manufacturers, standard setting organizations, research institutions or the like.

The controller 110 may tune voice quality of the communication device 10 by adjusting various parameters of the measuring items while determining the values of the measuring items in order of measuring items, that is, in order of RFR, RLR and ICN-R. The order of the measuring items may be determined according to how strongly they are influenced by each other. More specifically, if RFR influences RLR more than RLR influences RFR, then RFR may be adjusted before the RLR. The tuning performed by the controller 110 is described below in more detail.

The measuring unit 120 may be electrically connected to the communication device 10 and/or the controller 110. The connection may be established in a wired or wireless manner. The measuring unit 120 may determine whether the measuring items of the communication device 10 lie within standard ranges. In addition, the measuring unit 120 may apply the measuring results again to the controller 110 to allow the controller 110 to change one or more parameters and perform tuning again.

Hereinafter, a sequence of driving the voice quality optimization system according to an exemplary embodiment will be described in more detail.

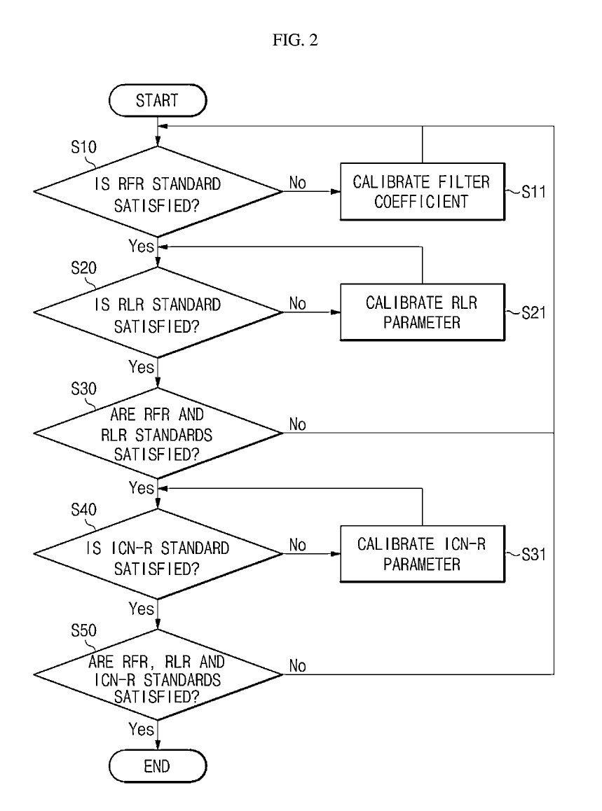

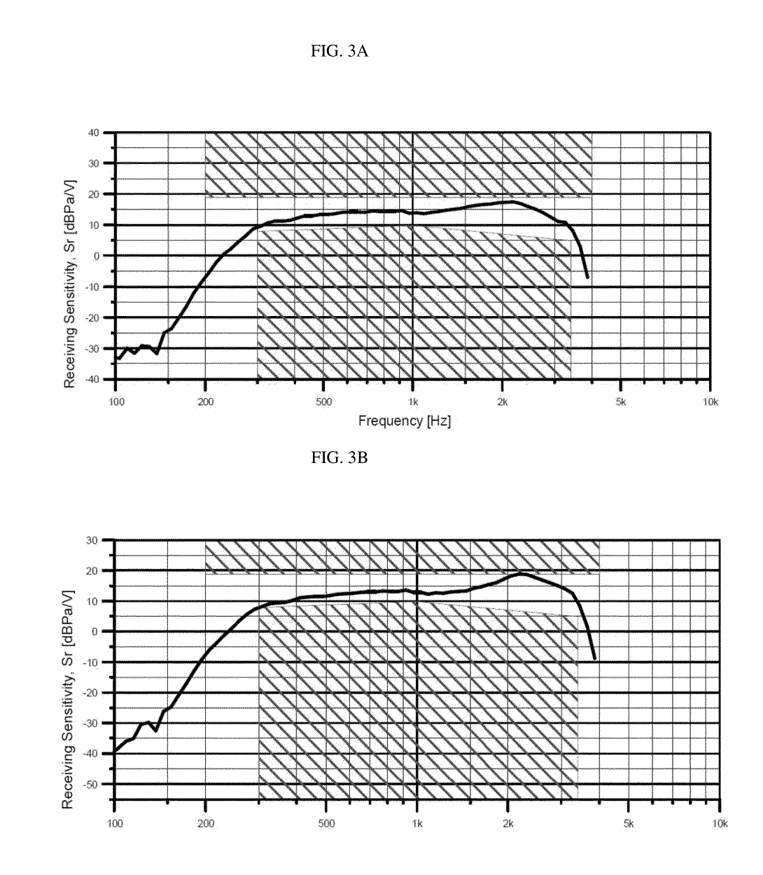

FIG. 2 is a flowchart illustrating a method for driving a voice quality optimization system according to an exemplary embodiment of the invention. FIG. 3A illustrates a target receiving sensitivity/frequency response (RFR) characteristic curve set in a voice quality optimization system according to an exemplary embodiment of the invention. FIG. 3B illustrates a measured RFR characteristic curve in a voice quality optimization system according to an exemplary embodiment of the invention. This method will be described as if performed by the voice quality optimization system 100 of FIG. 1, but is not limited as such.

Referring first to FIG. 2, in the voice quality optimization system 100, the controller 110 determines whether the RFR characteristic curve of the communication device 10 satisfies a target standard (S10).

Referring to FIG. 3A, together with FIG. 2, the controller 110 sets a target RFR characteristic curve that may satisfy the RFR standard. In FIG. 3A, the target RFR characteristic curve is illustrated as a graphical representation of receiving sensitivity levels in different frequency bands. To this end, the controller 110 may select the target RFR characteristic curve customized to the type of the communication device 10 or may set a general target RFR characteristic curve. The target RFR characteristic curve may be selected among existing RFR characteristic curves or may be directly set (i.e., drawing a desired RFR characteristic using a mouse, or similar instrument). In addition, the target RFR characteristic curve may be set to conform to the standard requirement by allowing the target RFR characteristic curve to be positioned between mask regions (indicated by shaded regions in FIG. 3A), which may be specified by various communication companies, standard setting organizations, research institutions or the like.

The measuring unit 120 obtains the RFR characteristic curve of the communication device 10 and transmits the same to the controller 110. The controller 110 compares the RFR characteristic curve with the target RFR characteristic curve while varying pulse code modulation (PCM) filter parameters. Here, the PCM filter parameters may include 7 filter coefficients in a transmitter side and a receiver side.

If the controller 110 determines that the RFR standard has not been satisfied, the controller 110 calibrates the filter coefficients over a period of a given number of sets N (S11), and controls the measuring unit 120 to obtain the RFR characteristic curve of the communication device 10 to derive a final parameter from the filter coefficients in the RFR characteristic curve. The RFR characteristic curve corresponding to the final parameter may be similar to the target RFR characteristic curve. In addition, while the number of sets N is described to range to 100, but may be fewer or greater.

The RFR characteristic curve of the communication device 10 selected by the optimized parameter is shown in FIG. 3B. As shown in FIG. 3B, the RFR characteristic curve is similar to the target RFR characteristic curve shown in FIG. 3A and is positioned between the masked regions (indicated by shaded regions), as it may be set forth by various communication companies, standard setting organizations, research institutions or the like.

If the RFR characteristic curve of the communication device 10 is not positioned between the mask regions, that is, if the RFR characteristic curve does not meet or satisfy the target RFR standard, the controller 10 recalibrates the filter coefficient (S11) to produce another RFR characteristic curve, which may meet or satisfies the target RFR standard. This step of obtaining again the RFR characteristic curve of the communication device 10 may be repeatedly performed until a satisfactory RFR characteristic curve is produced or until other reference conditions are met.

If RFR characteristic curve of the communication device 10 is determined to have met or satisfied the RFR standard, the controller 110 determines whether the RLR standard of the communication device 10 is satisfied (S20). If the controller 110 determines that the RLR standard has been satisfied, the routine proceeds to a next step (S30). If the controller determines that the RLR standard has not been satisfied, the RLR parameter is calibrated (S21).

More specifically, in order to tune the RLR, the controller 110 may adjust codec gain and volume parameters. If the codec and volume parameters are increased, the RLR may decrease in response. The controller 110 may adjust the RLR to be positioned within a target standard range by selecting a target RLR, comparing the target RLR with the measured RLR of the communication device 10 to obtain a difference between the target RLR and the measured RLR of the communication device 10, adjusting the codec gain based on the difference, and adjusting the volume (S21).

If the RLR is determined to be positioned within the target standard range, the controller 110 may check again to determine whether the RFR standard remains satisfied (S30).

The rechecking step may be performed because the parameter of the RFR characteristic curve may be affected or changed by the RLR parameter while calibrating the RLR parameter. Accordingly, even after the calibrating of the RLR parameter (S21), the measuring unit 120 may check again to determine whether the RFR characteristic curve is positioned within the standard range.

If the controller 110 determines that the measured RFR characteristic curve and the RLR characteristic curve are positioned within the standard range, the controller 110 checks to determine whether the ICN-R standard of the communication device 10 is satisfied (S40).

If so, the routine proceeds to a next step, and if not, the ICN-R parameter is calibrated (S41), thereby adjusting the ICN-R to be positioned within an ICN-R standard range.

Further, although not illustrated, one or more additional checks after the initial calibration of RFR, RLR, and ICN-R may be omitted for efficiency.

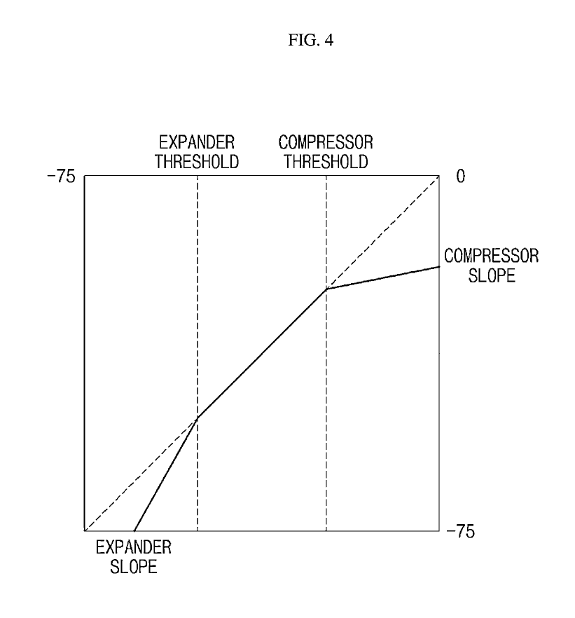

FIG. 4 is a graph illustrating idle channel noise-receiving parameters in a voice quality optimization system according to an exemplary embodiment of the invention.

Referring to FIG. 4, the controller 110 may control idle channel noise-receiving (ICN-R) characteristic curve by adjusting parameters of auto gain control (AGC). The AGC may perform to automatically change an amplification factor, such that an output of an input signal is within a target range. The AGC parameters may include, without limitation, a static gain, an expander threshold, and an expander slope. The controller 110 may control the ICN-R to satisfy the target standard range by calibrating the static gain, the expander threshold, and the expander slope.

The static gain may be used to adjust AGC-based input signals to be tuned to the gain. In addition, the expander threshold and the expander slope may be used to define a target standard range of input signals by adjusting low levels of the input signals. An output-to-input proportion may be adjusted by adjusting the expander slope. Accordingly, by calibrating the static gain, the expander threshold, and the expander slope, the ICN-R may be tuned.

In addition, while calibrating the ICN-R parameter (S41), the previously tuned parameters of the RFR characteristic curve and the RLR may be changed. Thus, the controller 110 rechecks the RFR, RLR and ICN-R parameters in that order to determine whether they satisfy their respective standards (S50).

If the RFR, RLR and ICN-R parameter standards are all satisfied, the voice quality optimization process is terminated. However, if any one of the parameter standards is not satisfied, the voice quality optimization method may goes back to the initial step to calibrate again the respective parameters for the RFR characteristic curve, the RLR and the ICN-R. Further, the routine may loop back to fix only the faulty parameter(s) (i.e., if only RLR parameter is determined to be faulty, the routine may go back to step S20 rather than starting from the beginning).

Although not illustrated, similar routine or operations may be performed to adjust the sending parameter as well, which may include, without limitation, a sending sensitivity/frequency response (SFR), a sending loudness rating (SLR), and an idle channel noise-sending (ICN-S) as well.

Hereinafter, tests carried out by the voice quality optimization system according to an exemplary embodiment of the present invention will be described.

Table 1 below shows a target standard range for RLR and ICN-R, comparison results of RLR and ICN-R standard parameters tuned automatically by the voice quality optimization system, and RLR and ICN-R standard parameters tuned by an engineer. In addition, similar information related to SLR and ICN-S parameters are provided as well.

TABLE 1

| | | | | Automated |
|---|---|---|---|---|
| Category | | Target Standard | Manual Tuning | Tuning |
| Receiving | RLR [dB] | −1~−3 | −2.10 | −1.98 |
| | ICN-R | −65 | −65.57 | −66.71 |
| Sending | SLR [dB] | 11~13 | 13.07 | 12.42 |
| | ICN-S | −75 | −78.70 | −76.66 |

As confirmed from Table 1, in the voice quality optimization system 100, the RLR and ICN-R target standard range in a receiving stage are both satisfied. In addition, SLR and ICN-S target standard range in a sending stage are also satisfied.

Table 2 below shows comparison results of tuning time measured when tuning is automatically performed by the voice quality optimization system according to the embodiment of the present invention and when tuning is manually performed by an engineer.

TABLE 2

| | | Manual Tuning | Automated | Curtailed |
|---|---|---|---|---|
| Category | Measuring Item | [min] | Tuning | Time [min] |
| Receiving | RFR | 60 | 4 | 56 |
| | RLR | 40 | 4 | 36 |
| | ICN-R | 50 | 7 | 43 |
| Sending | SFR | 90 | 5 | 85 |
| | SLR | 20 | 3 | 17 |
| | ICN-S | 30 | 3 | 27 |

| | | | |
|---|---|---|---|
| Total tuning time [min] | 290 | 26 | 264 |

As confirmed from Table 2, the voice quality optimization system 100 curtailed the tuning time for optimizing voice quality. As shown in Table 2, tuning time was curtailed by 135 minutes in a receiving stage and 129 minutes in a sending stage. In addition, while manual tuning performed by an engineer used a total tuning time of 264 minutes, the voice quality optimization system 100 used a total tuning time of 26 minutes, or approximately 1/10^{th} of the manual tuning time.

Therefore, the voice quality optimization system 100 may be able to secure voice quality by satisfying the voice quality standard while maintaining quality uniformity.

In addition, in a case where the voice quality optimization system 100 is used in a production line, different parameters of terminals, even if the terminals are of the same model, can be adjusted so as to be suited to characteristics of the respective terminals, which may improve the overall voice quality of the respective terminals.

Further, in the voice quality optimization system 100, a tuning time may be reduced, compared to a conventional manual system, which would further increase the productivity.

Hereinafter, a configuration of a voice quality optimization system according to an exemplary embodiment of the present invention will be described.

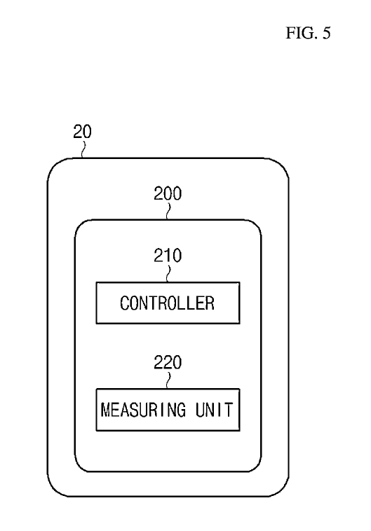

FIG. 5 is a schematic diagram illustrating a voice quality optimization system according to an exemplary embodiment of the invention.

Referring to FIG. 5, a voice quality optimization system 200 is embedded or enclosed in a communication device 20. In addition, the voice quality optimization system 200 further includes a controller 210 and a measuring unit 220.

Here, the communication device 20 may be in the form of a smart phone, a two way radio, and the like. The controller 210 and the measuring unit 220 may be implemented as processors embedded in the communication device 20, for example, in forms of digital signal processing (DSP) chips.

The controller 210 and the measuring unit 220 may be executed by incorporating operations provided in the communication device or separate applications, thereby activating voice quality optimization. Therefore, individual users may activate operations of the controller 210 and the measuring unit 220 to calibrate parameters to be suited for the individual user.

Here, operations of the controller 210 and the measuring unit 220 may be similar to or the same as those of the controller 110 and the measuring unit 120 described above. Therefore, the controller 210 may determine whether parameters of the communication device 20 satisfy the respective standards, including RFR characteristic curve, RLR and ICN-R. Further, the controller 210 and the measuring unit 220 may also repeatedly measure and adjust parameters to be within target standard ranges in the respective stages.

As described above, the voice quality optimization system 200 includes the controller 210 and the measuring unit 220 embedded or enclosed in the communication device 20, which are executed based on one or more applications to allow individual users to calibrate the parameters in person, thereby achieving voice quality suited for the individual users.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A voice quality optimization system, comprising:
a measuring unit to obtain parameters of a communication device, wherein the parameters comprise a receiving sensitivity/frequency response (RFR), receiving loudness rating (RLR), and idle channel noise-receiving (ICN-R); and
a controller to determine whether the parameters of the communication device are within a target range, and to calibrate a first parameter to be within the target range if the first parameter is outside the target range.

2. The voice quality optimization system of claim 1, wherein RFR is calibrated before RLR and ICN-R.

3. The voice quality optimization system of claim 1, wherein the controller compares a measured RFR characteristic curve to a target RFR characteristic curve and varies pulse code modulation (PCM) filter parameters to determine whether RFR is determined to be within the target RFR range.

4. The voice quality optimization system of claim 1, wherein the controller calibrates the RFR by calibrating filter coefficients and obtains a RFR characteristic curve that satisfies the target RFR range to derive a second parameter from the filter coefficient.

5. The voice quality optimization system of claim 1, wherein the controller calibrates RLR by adjusting a codec gain and a volume parameter.

6. The voice quality optimization system of claim 1, wherein the controller adjusts parameters of auto gain control (AGC) to calibrate the ICN-R.

7. The voice quality optimization system of claim 6, wherein the parameters of AGC include at least one of a static gain, an expander threshold, and an expander slope.

8. The voice quality optimization system of claim 7, wherein the controller further adjusts AGC based input signals by using the static gain, adjusts a low level of input signals of a target range of input signals, wherein the target range of input signals are based on the expander threshold and the expander slope, and adjusts an output-to-input proportion using the expander slope.

9. The voice quality optimization system of claim 1, wherein the measuring unit and controller are incorporated in a communication device.

10. A method for setting voice optimization in a communication device, comprising:
measuring parameters of the communication device with a measuring unit, wherein the parameter comprises at least one of a receiving sensitivity/frequency response (RFR), receiving loudness rating (RLR), and idle channel noise-receiving (ICN-R);
s determining with a controller whether the parameters of the communication device are within a target range; and
calibrating a first parameter to be within the target range with the controller if the first parameter is outside the target range.

11. The method of claim 10, wherein RFR is calibrated before RLR and ICN-R.

12. The method of claim 10, wherein RFR is determined to be within the target RFR range by comparing a measured RFR characteristic curve to a target RFR characteristic curve and varying pulse code modulation (PCM) filter parameters.

13. The method of claim 10, wherein RFR is calibrated by calibrating filter coefficients and obtaining a RFR characteristic curve that satisfies the target RFR range to derive a second parameter from the filter coefficient.

14. The method of claim 10, wherein RLR is calibrated by adjusting a codec gain and a volume parameter.

15. The method of claim 10, wherein ICN-R is calibrated by adjusting parameters of auto gain control (AGC).

16. The method of claim 15, wherein the parameters of AGC include at least one of a static gain, an expander threshold, and an expander slope.

17. The method of claim 16, wherein adjusting parameters of AGC comprises:
adjusting AGC based input signals by using the static gain,
adjusting a low level of input signals of a target range of input signals, wherein the target range of input signals is based on the expander threshold and the expander slope, and
adjusting an output-to-input proportion using the expander slope.

18. The method of claim 17, further comprising determining whether RFR remains within the target RFR range, if RLR or ICN-R is calibrated.

19. The method of claim 10, further comprising determining whether RFR and the RLR remain within their respective target ranges, if ICN-R is calibrated.

20. A method for setting voice optimization in a communication device, comprising:
measuring parameters of the communication device, wherein the parameters comprise a receiving sensitivity/frequency response (RFR), receiving loudness rating (RLR), and idle channel noise-receiving (ICN-R);
determining whether RFR is within a target RFR range, and calibrating filter coefficient if RFR is determined not to be within the target RFR range;
determining whether RLR is within a RLR range, and calibrating RLR parameter if RLR is determined not to be within the target RLR range; and
determining whether ICN-R is within a ICN-R range, and calibrating ICN-R parameter if ICN-R is determined not to be within the target ICN-R range,
wherein RFR is rechecked to determine whether RFR remains within the target RFR range after RLR or ICN-R is calibrated, and
RFR and RLR are rechecked to determine whether the RFR and the RLR remain within their respective target ranges after ICN-R is calibrated.
